(19) United States
(12) Patent Application Publication
(10) Pub. No.: US 2023/0409115 A1
(43) Pub. Date: Dec. 21, 2023

(54) SYSTEMS AND METHODS FOR CONTROLLING A DIGITAL OPERATING DEVICE VIA AN INPUT AND PHYSIOLOGICAL SIGNALS FROM AN INDIVIDUAL

(71) Applicant: LENOVO (SINGAPORE) PTE, LTD, NEW TECH PARK (SG)

(72) Inventors: Russell Speight Vanblon, Raleigh, NC (US); Thorsten Stremlau, Morrisville, NC (US); Kevin W. Beck, Raleigh, NC (US); David Schwarz, Morrisville, NC (US)

(21) Appl. No.: 17/751,771

(22) Filed: May 24, 2022

(51) Int. Cl. G06F 3/01; G06F 3/16

(52) U.S. Cl. CPC G06F 3/015; G06F 3/167

(57) ABSTRACT

A system and a method include a digital operating device configured to receive an input from an individual. The input is configured to provide a command for operating one or more aspects of one or more components. One or more sensors are configured to detect one or more physiological signals of the individual. A correlation control unit is configured to receive the one or more physiological signals from the one or more sensors. The correlation control unit is further configured to determine an intent of the individual based on the one or more physiological signals. The digital operating device is further configured to control the one or more aspects of the one or more components based on the input, as received from the individual, and the intent of the individual, as determined by the correlation control unit.

### BACKGROUND

Embodiments of the present disclosure generally relate to systems and methods for determining commands, such as voice commands, in relation to a digital operating device that is configured to control operation of one or more components.

Digital personal assistants (DPAs) are used by individuals to perform various tasks. A DPA can receive voice commands from an individual and operate various components based on the voice commands. As an example, a DPA can receive voice commands from an individual to broadcast desired music through a speaker. As another example, a DPA can receive a voice command to initiate a call via a telephone. As another example, a user can operate lighting within a room through a DPA. As another example, a user can operate various appliances through a DPA.

However, at times, a DPA may be unable to accurately distinguish a voice command from an individual for various reasons. Crowd noise within a setting can distort a voice command. As another example, an individual can misspeak or otherwise provide an ambiguous voice utterance. In general, voice utterances received by a DPA can be ambiguous for various reasons, such as caused by distance between an individual and the DPA, background noise, unclear speaking, low voice volume, an accent, a dialect, and/or the like.

### SUMMARY

A need exists for a system and a method for clarifying inputs received by a digital personal assistant. Further, a need exists for a system and a method for accurately determining a meaning of an input, such as a voice command, received by a digital personal assistant.

With those needs in mind, certain examples of the present disclosure provide a system including a digital operating device configured to receive an input from an individual. The input is configured to provide a command for operating one or more aspects of one or more components. One or more sensors are configured to detect one or more physiological signals of the individual. A correlation control unit is configured to receive the one or more physiological signals from the one or more sensors. The correlation control unit is further configured to determine an intent of the individual based on the one or more physiological signals. The digital operating device is further configured to control the one or more aspects of the one or more components based on the input, as received from the individual, and the intent of the individual, as determined by the correlation control unit.

In at least one example, the digital operating device is a digital personal assistant.

The one or more components can include one or more of an appliance, a radio, a lighting system, an alarm system, or a telephone.

In at least one example, the input includes one or more of a voice utterance, a physical gesture, or eye motion.

In at least one example, the one or more sensors include one or both of an electroencephalographic (EEG) sensor, or an electromyographic (EMG) sensor, and the one or more physiological signals include one or both of one or more EEG signals or one or more EMG signals.

In at least one example, the digital operating device includes the correlation control unit. In at least one other example, the correlation control unit is separate and distinct from the digital operating device. In at least one example, a handheld device of the individual includes the correlation control unit.

In at least one example, in response to a discrepancy existing between the input and the intent of the individual, the digital operating device is further configured to prompt the individual for clarification regarding the input.

In at least one example, the correlation control unit is an artificial intelligence or machine learning system.

In at least one example, the one or more sensors are on or within one or more of a handheld device, a headset, or an earpiece.

Certain examples of the present disclosure provide a method including receiving, by a digital operating device, an input from an individual, wherein the input is configured to provide a command for operating one or more aspects of one or more components; detecting, by one or more sensors, detect one or more physiological signals of the individual; receiving, by a correlation control unit, the one or more physiological signals from the one or more sensors; determining, by the correlation control unit, an intent of the individual based on the one or more physiological signals; and controlling, by the digital operating device, the one or more aspects of the one or more components based on the input, as received from the individual, and the intent of the individual, as determined by the correlation control unit.

In at least one example, the method also includes in response to a discrepancy existing between the input and the intent of the individual, prompting, by the digital operating device, the individual for clarification regarding the input.

### BRIEF DESCRIPTION OF THE DRAWINGS

FIG. 1 illustrates a schematic block diagram of a system, according to an example of the present disclosure.

FIG. 2 illustrates a block diagram of sensors, according to an example of the present disclosure.

FIG. 3 illustrates a front view of a handheld device, according to an example of the present disclosure.

FIG. 4 illustrates a front view of a headset, according to an example of the present disclosure.

FIG. 5 illustrates a front view of an earpiece, according to an example of the present disclosure.

FIG. 6 illustrates a flow chart of a method, according to an example of the present disclosure.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

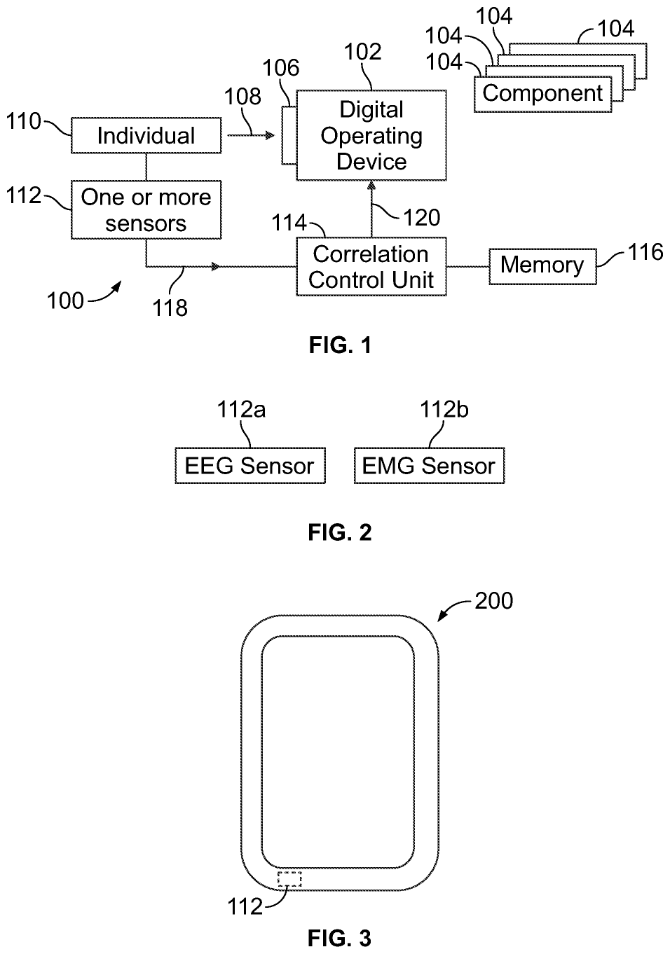

FIG. 1 illustrates a schematic block diagram of a system 100, according to an example of the present disclosure. The system 100 includes a digital operating device 102 that is configured to control one or more operational aspects of one or more components 104. As an example, the digital operating device 102 is a digital personal assistant (DPA). As another example, the digital operating device 102 is a control system within a fixed structure, vehicle, or the like. For example, the digital operating device 102 can be a processor-based operating system within an automobile. In at least one example, the digital operating device 102 is in communication with a handheld device, such as a smart phone, smart tablet, or the like. In at least one example, the digital operating device 102 is or otherwise includes a smart phone, smart tablet, or the like.

Examples of the components 104 include various appliances, applications, systems, and the like. For example, a component 104 can be or include one or more appliances within a residence. As another example, a component 104 can be or include a radio, digital recorder or music player, or the like. As another example, a component 104 can be or include interior lighting within a room, an interior of a vehicle, or the like. As another example, a component 104 can be or include an alarm system. As another example, a component 104 can be or include a telephone, such as part of a handheld smart device. The aforementioned examples of the components 104 are not limiting.

The digital operating device 102 is in communication with the one or more components 104 through one or more wired or wireless connections. The digital operating device 102 is configured to control one or more aspects of the one or more components 104. Examples of such aspect(s) include activation and deactivation, selection among one or more options, audio or video control, volume control, initiation of communication (such as initiation of a telephone call), and/or the like.

The digital operating device 102 includes one or more detectors 106 that are configured to receive an input 108 from an individual 110. Examples of the detectors 106 include a microphone, an optical device, such as a camera, and/or the like. For example, the digital operating device 102 includes a detector 106, such as a microphone, that receives the input 108, such as a voice utterance, from the individual 110. As another example, the digital operating device 102 includes a detector 106, such as a camera, that detects an input 108, such as a hand gesture, eye movement, or the like, of the individual 110. The input 108 can be one or more of a voice utterance, a physical gesture (such as a hand motion, head motion, or the like), eye motion, and/or the like.

One or more sensors 112 are coupled to the individual 110 and are configured to detect one or more physiological signals. The one or more sensors 112 can be connected to a portion of anatomy of the individual 110. For example, the one or more sensors 112 can be disposed on or within a headset worn by the individual 110. As another example, the one or more sensors 112 can be disposed on or within an earpiece worn by the individual 110. As another example, the one or more sensors 112 can be within a handheld device, such as a smart phone, held by the individual 110, such as within a hand or clothing of the individual 110.

In at least one example, the sensor 112 is an electroencephalographic (EEG) sensor that is configured to detect electrical activity of a brain (for example, a brain wave) of the individual. In this example, the sensor 112 detects an EEG signal, which is an example of a physiological signal.

In at least one example, the sensor 112 is an electromyographic (EMG) sensor that is configured to detect muscle response or electrical activity in response to nerve stimulation of a muscle. In this example, the sensor 112 detects an EMG signal, which is an example of a physiological signal.

The one or more sensors 112 can include one or both of an EEG sensor and/or an EMG sensor. In at least one example, the system includes both an EEG sensor and an EMG sensor.

Other examples of the sensors 112 include a heart rate sensor, a blood pressure sensor, a breathing rate sensor, a pulse oximeter, or the like. Various examples of sensor 112 configured to detect various physiological signals of the individual 110 can be used.

The system 100 also includes a correlation control unit 114 in communication with the one or more sensors 112, such as through one or more wired or wireless connections. The correlation control unit 114 includes or is otherwise in communication with a memory 116, such as through one or more wired or wireless connections. In at least one example, the digital operating device 102 includes the correlation control unit 114. In at least one other example, the digital operating device 102 is separate, distinct, and remote from the digital operating device 102. In at least one example, a handheld device of the individual 110 includes the correlation control unit 114. In at least one other example, the correlation control unit 114 is separate, distinct, and remote from a handheld device of the individual 110.

In operation, the digital operating device 102 receives the input 108 from the digital operating device 102. As the individual 110 provides the input 108 (such as a voice command, a physical gesture, or the like), the individual 110 also generates a physiological signal, which is associated with the input 108. For example, when the individual 110 generates a voice utterance (an example of the input 108), the individual 110 also provides one or more physiological signals at the same time. As such, the physiological signals are associated with the voice utterance. The physiological signals can be EEG signals, EMG signals, and/or the like. The one or more sensors 112 detect the one or more physiological signals 118, associated with the input 108, of the individual 110. The correlation control unit 114 receives the one or more physiological signals 118, as detected by the one or more sensors 112. The correlation control unit 114 then compares the one or more physiological signals 118 with data stored in the memory 116. The data relates to past commands associated with the physiological signals 118. For example, a command to operate a particular aspect of a component 104 is associated with a particular physiological signal 118, such as an EEG signal and/or an EMG signal. The data stored in the memory 116 can be preprogrammed, and may be based on crowd sourced data. As another example, the data stored in the memory 116 can be based on prior history of the individual 110. As another example, the data stored in the memory 116 can include crowd sourced data and prior history data of the individual 110.

The correlation control unit 114 analyzes the one or more physiological signals 118 in relation to the data stored in the memory 116 to determine an intent of the individual 110. For example, the physiological signal 118 is correlated with a predetermined or predefined intended command of the individual 110. The correlation control unit 114 can determine a confidence level of the intent of the individual 110 based on a comparison of the physiological signal 118 with the data stored in the memory 116.

The digital operating device 102 receives the input 108 from the individual 110 and a correlation signal 120 from the correlation control unit 114. Optionally, the correlation control unit 114 receives the input 108 from the digital operating device 102 and compares with the correlation signal 120. As noted, the digital operating device 102 can include the correlation control unit 114. The correlation signal 120 includes a determination of the intent of the individual 110 based on the analysis of the physiological signal(s) 118 (for example, a comparison of the physiological signal(s) 118 in relation to the data stored in the memory 116). The digital operating device 102 and/or the correlation control unit 114 compares the input 108 in relation to the correlation signal 120. If the input 108 and the correlation signal 120 are within a predefined agreement threshold (such as both being at least 70% confidence of a particular command), then the digital operating device 102 operates the one or more component(s) 104 based on the received input 108. If, however, a discrepancy exists between the input 108 and the correlation signal 120 (for example, the input 108 being less than 50% confidence of a particular command, and the correlation signal being greater than 80% confidence of a particular command), the digital operating device 102 may prompt the individual 110 for clarification. As an example, the digital operating device 102 can send an audible, text, or graphic message to the individual 110 asking for the input 108 to be communicated again, and/or a choice between different commands.

As such, the correlation control unit 114 provides a backup, confirmation, and/or redundancy check in relation to the input 108. The correlation control unit 114 receives the physiological signal(s) 118 from the one or more sensors 112, and analyzes the physiological signals(s) 118 to determine an intent of the individual 110. The physiological signal(s) 118 are associated with the input 108 in that they are contemporaneous, and are used by the correlation control unit 114 to confirm or reject the input 108 received by the digital operating device 102.

As an operational example, the individual 110 provides an input 108 to the digital operating device 102 in the form of a voice utterance to activate a particular component 104 (such as a lighting system, an appliance, a radio, or the like). The digital operating device 102 has previously received such input 108 in the past (for example, a period of days, weeks, months, etc.). For successful commands, the digital operating device 102 and/or the correlation control unit 114 stores data regarding physiological signals 118 associated with such commands in the memory 116. The physiological signals 118 can be one or both of EEG signals and/or EMG signals, as detected by the sensor(s) 112, associated with the commands. The correlation control unit 114 correlates such physiological signals 118 with the commands.

The individual 110 may then later provide the same command, such as via a voice utterance, but the digital operating device 102 has low confidence in relation to the command (such as due to background noise, low voice volume, and/or the like). Accordingly, the correlation control unit 114 analyzes the associated physiological signals 118 in relation to the data regarding past commands, as stored in the memory 116. The digital operating device 102 and/or the correlation control unit 114 compares such correlation signal 120 with the input 108 to find a match either when the user previously thought about specific objects, places, command-types, devices, etc. (for example, the when the physiological signal 118 is or includes an EEG signal), and/or used muscles which provided EMG waves (the physiological signal 118 is or includes an EMG signal) which had a high correlation to previous command usage. Based on the correlation signal 120, the digital operating device 102 can interpret the intent of the individual 110, even if the digital operating device 102 has low confidence (for example, 50% or less) of at least portions of the input 108.

Depending on the type of input 108, the analyzed physiological signals 118 can be one or both of EEG signals and/or EMG signals. For example, muscle-based user inputs (gesture & eye tracking) utilize muscles, but they also impact the user's brain waves. Voice can often be used with little muscle movement other than the mouth. If an EMG sensor is attached and can read signals from the individual 110, EMG signals can be used. Otherwise, EEG sensors can pick up any type of user input.

The correlation control unit 114 can build correlations for individual users, and/or crowdsourced among many users, which can be further used to provide default models for use with first-time users. The models can be refined as the individual 110 interacts with the digital operating device 102. Recorded data may never have to leave a device of the individual 110.

As described herein, the system 100 includes the correlation control unit 114, which receives the physiological signal(s) 118 from the one or more sensors 112. The correlation control unit 114 analyzes the physiological signal(s) 118 to determine an intent of the individual 110. The digital operating device 102 and/or the correlation control unit 114 compares the input 108 received from the individual 110 to the intent of the individual 110, as determined by the correlation control unit 114, to determine whether an action is to be taken by the digital operating device 102 in relation to the one or more components 104. If a difference between a confidence of analysis of the input 108 and analysis of the physiological signals 118 exists, the digital operating device 102 may operate according to the analysis of the physiological signals 118, as performed by the correlation control unit 114, and/or prompt the individual 110 for clarification.

As described herein, the system 100 includes the digital operating device 102, which is configured to control one or more aspects of the one or more components 104. The digital operating device 102 is configured to receive the input 108 from the individual 110. The input 108 is configured to provide a command for operating the one or more aspect of the one or more components 104. The one or more sensors 112 are configured to detect one or more physiological signals 118 of the individual 110. The correlation control unit 114 is configured to receive the one or more physiological signals 118 from the one or more sensors 112. The correlation control unit 114 is configured to determine an intent of the individual 110 based on the one or more physiological signals 118. The digital operating device 102 is further configured to control the one or more aspects of the one or more components 104 based on a comparison of the input 108 and the intent of the individual 110, as determined by the correlation control unit 114.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the correlation control unit 114 may be or include one or more processors that are configured to control operation, as described herein.

The correlation control unit 114 is configured to execute a set of instructions that are stored in one or more data storage units or elements (such as one or more memories), in order to process data. For example, the correlation control unit 114 may include or be coupled to one or more memories. The data storage units may also store data or other information as desired or needed. The data storage units may be in the form of an information source or a physical memory element within a processing machine.

The set of instructions may include various commands that instruct the correlation control unit 114 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the correlation control unit 114. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the correlation control unit 114 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In at least one example, all or part of the systems and methods described herein may be or otherwise include an artificial intelligence (AI) or machine-learning system that can automatically perform the operations of the methods also described herein. For example, the correlation control unit 114 can be an artificial intelligence or machine learning system. These types of systems may be trained from outside information and/or self-trained to repeatedly improve the accuracy with how the physiological signals 118 are correlated with user commands. Over time, these systems can improve by matching records with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), or the like. The systems may be trained and re-trained using feedback from one or more prior analyses of samples and/or data. Based on this feedback, the systems may be trained by adjusting one or more parameters, weights, rules, criteria, or the like, used in the analysis of the same or other samples. This process can be performed using generated data instead of training data, and may be repeated many times to repeatedly improve the correlation of commands. The training of the record matching system minimizes false positives and/or false negatives by performing an iterative training algorithm, in which the systems are retrained with an updated set of data and based on the feedback examined prior to the most recent training of the systems. This provides a robust analysis model that can better determine whether physiological signals are associated with particular commands while limiting the number of false positives.

FIG. 2 illustrates a block diagram of sensors 112, according to an example of the present disclosure. Referring to FIGS. 1 and 2, the one or more sensors 112 can include an EEG sensor 112a and an EMG sensor 112b. By using both the EMG sensor 112 and the EMG sensor 112b, additional layers of correlation redundancy can be used. As such, intent of the individual 110 can be determined with increased accuracy and confidence. Optionally, the system 100 can include one of the EEG sensor 112a or the EMG sensor 112b.

FIG. 3 illustrates a front view of a handheld device 200, according to an example of the present disclosure. The handheld device 200 can be a smart phone, or smart tablet, for example. The handheld device 200 can include the one or more sensors 112. Referring to FIGS. 1 and 3, the individual 110 may have the handheld device 200, and the sensors 112 of the handheld device 200 may detect the one or more physiological signals 118 of the individual 110.

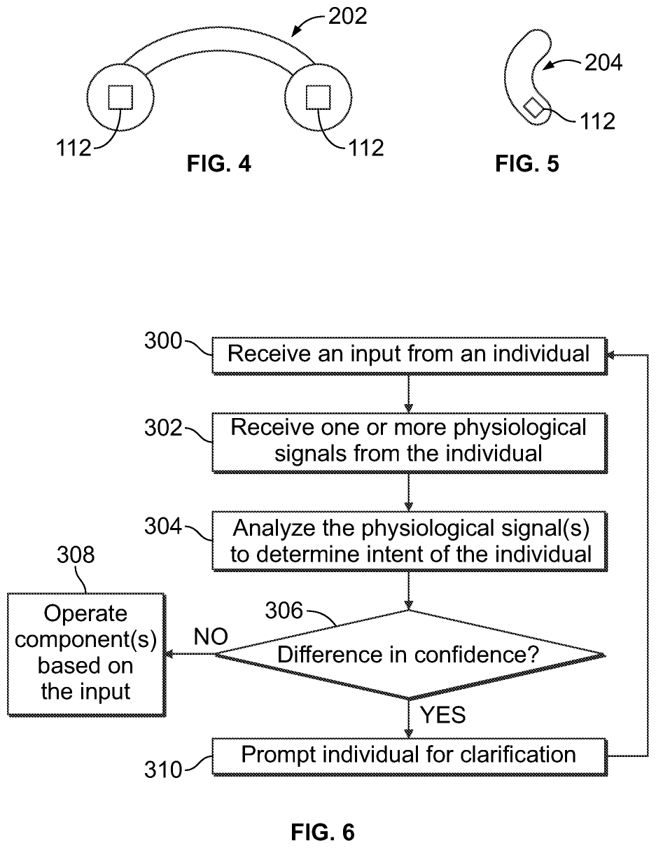

FIG. 4 illustrates a front view of a headset 202, according to an example of the present disclosure. Referring to FIGS. 1 and 4, the individual 110 can wear the headset 202, which can include the sensor(s) 112.

FIG. 5 illustrates a front view of an earpiece 204, according to an example of the present disclosure. Referring to FIGS. 1 and 4, the individual 110 can wear the earpiece 204, which can include the sensor(s) 112.

FIG. 6 illustrates a flow chart of a method, according to an example of the present disclosure. Referring to FIGS. 1 and 6, at 300, the digital operating device 102 receives the input 108 from the individual 110. At 302, the correlation control unit 114 receives the one or more physiological signals 118, as detected by the one or more sensors 112. At 304, the correlation control unit 114 analyzes the physiological signal(s) 118 (such as by comparing in relation to the data stored in the memory 116) to determine an intent of the individual 110. At 306, one or both of the digital operating device 102 and/or the correlation control unit 114 determines if there is a difference in confidence between the input 108 and the analysis of the physiological signal(s) 118. If not, the method proceeds to 308, at which the digital operating device 102 operates one or more of the component(s) 104 based on the input 108 received from the individual 110. If, however, there is a difference in confidence, the method proceeds from 306 to 310, at which the digital operating device 102 prompts the individual for clarification as to the input 108. The method then returns to 300. Optionally, instead of prompting for clarification, the digital operating device 102 can operate the component(s) 104 based on the analysis of the physiological signal(s) 118.

Further, the disclosure comprises embodiments according to the following clauses:

Clause 1: A system comprising:
a digital operating device configured to receive an input from an individual, wherein the input is configured to provide a command for operating one or more aspects of one or more components;
one or more sensors configured to detect one or more physiological signals of the individual; and
a correlation control unit configured to receive the one or more physiological signals from the one or more sensors, wherein the correlation control unit is further configured to determine an intent of the individual based on the one or more physiological signals, and wherein the digital operating device is further configured to control the one or more aspects of the one or more components based on the input, as received from the individual, and the intent of the individual, as determined by the correlation control unit.

Clause 2. The system of Clause 1, wherein the digital operating device is a digital personal assistant.

Clause 3. The system of Clauses 1 or 2, wherein the one or more components comprise one or more of an appliance, a radio, a lighting system, an alarm system, or a telephone.

Clause 4. The system of any of Clauses 1-3, wherein the input comprises one or more of a voice utterance, a physical gesture, or eye motion.

Clause 5. The system of any of Clauses 1-4, wherein the one or more sensors comprise one or both of an electroencephalographic (EEG) sensor, or an electromyographic (EMG) sensor, and wherein the one or more physiological signals comprise one or both of one or more EEG signals or one or more EMG signals.

Clause 6. The system of any of Clauses 1-5, wherein the digital operating device comprises the correlation control unit.

Clause 7 The system of any of Clauses 1-5, wherein the correlation control unit is separate and distinct from the digital operating device.

Clause 8. The system of any of Clauses 1-5, wherein a handheld device of the individual comprises the correlation control unit.

Clause 9. The system of any of Clauses 1-8, wherein in response to a discrepancy existing between the input and the intent of the individual, the digital operating device is further configured to prompt the individual for clarification regarding the input.

Clause 10. The system of any of Clauses 1-9, wherein the correlation control unit is an artificial intelligence or machine learning system.

Clause 11. The system of any of Clauses 1-10, wherein the one or more sensors are on or within one or more of a handheld device, a headset, or an earpiece.

Clause 12. A method comprising:
receiving, by a digital operating device, an input from an individual, wherein the input is configured to provide a command for operating one or more aspects of one or more components;
detecting, by one or more sensors, detect one or more physiological signals of the individual;
receiving, by a correlation control unit, the one or more physiological signals from the one or more sensors;
determining, by the correlation control unit, an intent of the individual based on the one or more physiological signals; and
controlling, by the digital operating device, the one or more aspects of the one or more components based on the input, as received from the individual, and the intent of the individual, as determined by the correlation control unit.

Clause 13. The method of Clause 12, wherein the digital operating device is a digital personal assistant.

Clause 14. The method of Clauses 12 or 13, wherein the one or more components comprise one or more of an appliance, a radio, a lighting system, an alarm system, or a telephone.

Clause 15. The method of any of Clauses 12-14, wherein the input comprises one or more of a voice utterance, a physical gesture, or eye motion.

Clause 16. The method of any of Clauses 12-15, wherein the one or more sensors comprise one or both of an electroencephalographic (EEG) sensor, or an electromyographic (EMG) sensor, and wherein the one or more physiological signals comprise one or both of one or more EEG signals or one or more EMG signals.

Clause 17. The method of any of Clauses 12-16, wherein the digital operating device comprises the correlation control unit.

Clause 18 The method of any of Clauses 12-16, wherein the correlation control unit is separate and distinct from the digital operating device.

Clause 19. The method of any of Clauses 12-16, wherein a handheld device of the individual comprises the correlation control unit.

Clause 20. The method of any of Clauses 12-19, further comprising, in response to a discrepancy existing between the input and the intent of the individual, prompting, by the digital operating device, the individual for clarification regarding the input.

As described herein, examples of the present disclosure provide systems and methods for clarifying inputs received by a digital operating device, such as a digital personal assistant. Further, examples of the present disclosure provide systems and methods for accurately determining a meaning of an input, such as a voice command, received by a digital operating device.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A system comprising:
a digital operating device configured to receive an input from an individual, wherein the input is configured to provide a command for operating one or more aspects of one or more components;
one or more sensors configured to detect one or more physiological signals of the individual; and
a correlation control unit configured to receive the one or more physiological signals from the one or more sensors, wherein the one or more physiological signals differ from, are contemporaneous with, and are associated with the input, wherein the correlation control unit is further configured to determine an intent of the individual based on the one or more physiological signals, and wherein the digital operating device is further configured to control the one or more aspects of the one or more components based on the input, as received from the individual, and the intent of the individual, as determined by the correlation control unit.

2. The system of claim 1, wherein the digital operating device is a digital personal assistant.

3. The system of claim 1, wherein the one or more components comprise one or more of an appliance, a radio, a lighting system, an alarm system, or a telephone.

4. The system of claim 1, wherein the input comprises one or more of a voice utterance, a physical gesture, or eye motion.

5. The system of claim 1, wherein the one or more sensors comprise one or both of an electroencephalographic (EEG) sensor, or an electromyographic (EMG) sensor, and wherein the one or more physiological signals comprise one or both of one or more EEG signals or one or more EMG signals.

6. The system of claim 1, wherein the digital operating device comprises the correlation control unit.

7. The system of claim 1, wherein the correlation control unit is separate and distinct from the digital operating device.

8. The system of claim 1, wherein a handheld device of the individual comprises the correlation control unit.

9. The system of claim 1, wherein in response to a discrepancy existing between the input and the intent of the individual, the digital operating device is further configured to prompt the individual for clarification regarding the input.

10. The system of claim 1, wherein the correlation control unit is an artificial intelligence or machine learning system.

11. The system of claim 1, wherein the one or more sensors are on or within one or more of a handheld device, a headset, or an earpiece.

12. A method comprising:
receiving, by a digital operating device, an input from an individual, wherein the input is configured to provide a command for operating one or more aspects of one or more components;
detecting, by one or more sensors, detect one or more physiological signals of the individual wherein the one or more physiological signals differ from, are contemporaneous with, and are associated with the input;
receiving, by a correlation control unit, the one or more physiological signals from the one or more sensors;
determining, by the correlation control unit, an intent of the individual based on the one or more physiological signals; and
controlling, by the digital operating device, the one or more aspects of the one or more components based on the input, as received from the individual, and the intent of the individual, as determined by the correlation control unit.

13. The method of claim 12, wherein the digital operating device is a digital personal assistant.

14. The method of claim 12, wherein the one or more components comprise one or more of an appliance, a radio, a lighting system, an alarm system, or a telephone.

15. The method of claim 12, wherein the input comprises one or more of a voice utterance, a physical gesture, or eye motion.

16. The method of claim 12, wherein the one or more sensors comprise one or both of an electroencephalographic (EEG) sensor, or an electromyographic (EMG) sensor, and wherein the one or more physiological signals comprise one or both of one or more EEG signals or one or more EMG signals.

17. The method of claim 12, wherein the digital operating device comprises the correlation control unit.

18. The method of claim 12, wherein the correlation control unit is separate and distinct from the digital operating device.

19. The method of claim 12, wherein a handheld device of the individual comprises the correlation control unit.

20. The method of claim 12, further comprising, in response to a discrepancy existing between the input and the intent of the individual, prompting, by the digital operating device, the individual for clarification regarding the input.
